(19) United States
(12) Patent Application Publication
(10) Pub. No.: US 2014/0366143 A1
(43) Pub. Date: Dec. 11, 2014

(54) METHOD FOR RISK ASSESSMENT OF APPLICATIONS BASED ON REQUESTED PERMISSIONS

(71) Applicant: Eran SANDLER, Ramat Gan (IL)

(72) Inventor: Eran SANDLER, Ramat Gan (IL)

(21) Appl. No.: 14/300,304

(22) Filed: Jun. 10, 2014

Related U.S. Application Data
(60) Provisional application No. 61/832,983, filed on Jun. 10, 2013.

(51) Int. Cl. G06F 21/57

(52) U.S. Cl. CPC G06F 21/577; G06F 2221/033
USPC 726/25

(57) ABSTRACT

A system and method for risk assessment of installing and executing of an application executable on a platform, the method comprising: categorizing the application to one of a list of application categories, comparing permissions requested by the application to a predetermined list of permissions related to the category of the application and representing a permissible level of risk, and providing information indicative of a level of correlation between the permissions requested by the application and the predetermined list of permissions.

### CROSS REFERENCE TO RELATED APPLICATIONS

This application claims the benefit of U.S. Provisional Patent Application No. 61/832,983, filed on Jun. 10, 2013 and entitled METHOD FOR RISK ASSESSMENT OF APPLICATIONS BASED ON REQUESTED PERMISSIONS, which is incorporated in its entirety herein by reference.

### BACKGROUND OF THE INVENTION

Many popular software platforms may require a user to grant an application permission to access certain information, to operate certain facilities or to use certain capabilities of the platform, before or during installation of the application or during the execution of the application. Typically, a list of permissions that are required by the application is presented to the user, and the user may either grant or deny these permissions. Denying a request for permission would usually result in the application not being installed or cause the application to disable certain features.

The process of presenting the required permissions to the user and asking him to grant these permissions is intended to protect the user from malicious applications. However, in real life, many users don't have the required background or patience to scan through the list of requested permissions, understand each one of them, recognize the risk embedded in a certain given permission and decide whether the application is safe or poses undesired risk.

### SUMMARY OF THE INVENTION

According to certain embodiments of the present invention, there is provided a method for risk assessment of an application executable on a platform, the method may include: categorizing the application to one of a list of application categories; comparing permissions requested by the application to a predetermined list of permissions related to the category of the application and representing a permissible level of risk; and providing information indicative of a level of correlation between the permissions requested by the application and the predetermined list of permissions.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart illustration of a method for risk assessment of an application according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

According to certain embodiments of the preset invention, risk assessment of an application that is about to be installed, or that is already installed on a platform, may be achieved by categorizing the application to one or more of a list of application categories, comparing permissions requested by the application upon or during installation or during the execution of the application to a predetermined list of permissions related to the category of the application and representing a permissible level of risk, and providing information indicative of a level of correlation between the permissions requested by the application and the predetermined list of permissions. A risk factor representing the potential risk that the application poses may be evaluated or calculated based on the level of correlation.

As used herein, a platform may relate to the underlying software executable by a computing device, for launching other software applications, or in other words, a platform may relate to software that is a base for other applications. The platform may allow an application access to certain information, capabilities or resources of the platform. Platforms may include operating systems such as iOS®, Android™, Windows Phone™ etc., social network platforms such as Facebook®, Twitter®, Linkedin®, etc., and internet browsers such as Firefox™, Internet Explorer®, Google Chrome™, Safari® etc. An application distribution platform may refer to a software platform from which an application may be downloaded.

As used herein, an application may refer to software code that may be installed on the platform and add functionality to the platform. Applications are often developed by a third party, e.g., not by the developer of the platform. Applications may be internet (web) based or native—mobile or PC based. To perform their intended functionality, applications need access to certain information, capabilities or resources of the platform. These capabilities may include Internet access, writing to the memory, e.g., writing to the Secure Digital (SD) card, monitoring the location of the user and sending SMS messages. In many platforms, applications request the user's permission to access these capabilities before or during installation of the application or during the execution of the application.

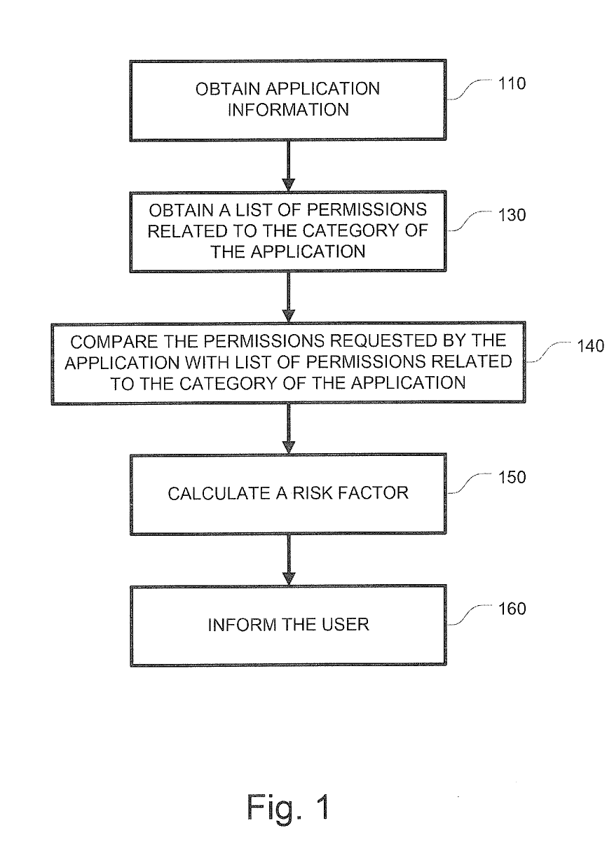

Reference is now made to FIG. 1, which is a flowchart illustration of a method for risk assessment of an application according to certain embodiments of the present invention. As used herein, a risk may include situations in which an application performs actions that may cause harm to the platform, to other applications whether the application is executed when the harm is done, or not, or to the integrity of saved content or may misuse the platform facilities. Such actions may include sending e-mails or short message service (SMS) massages to the members of the contact list of the user, copying the contact list of the user, invading the user privacy, etc.

According to certain embodiments of the present invention, risk assessment of a certain application may be performed upon installation of the application. Thus, the user may be notified of the risk involved in the application prior to the installation. This information may aid the user in deciding whether to install the application or not. According to some embodiments, applications that are already installed may be scanned and their risk may be evaluated. In this case the user may decide to remove applications based on their risk.

According to certain embodiments of the present invention, application information may be obtained, as indicated in block 110. The information may be obtained prior to installation, during the installation or after the installation of the application. The information may include parameters which are related to the application such as, but not limited to:
Developer identity, e.g., the developer name or a developer identification number.
Developer reputation. Developer reputation may be a rank or parameter indicative of the perceived level of safety associated with the developer of the application. The developer reputation may be derived based on past experience with that developer. For example, the developer reputation may be calculated based, inter alia, on some or all of the following parameters: the number of applications the developer has for the platform, the number of applications the developer has for other platforms, the number of removed applications the developer has for various platforms, the number of trusted applications the developer has for various platforms and the number of reported applications the developer has for various platforms. As used herein, reported applications include applications for which a report regarding a possible risk associated with the application or a report of an unexpected response of the application has been received from a user. The report may include information regarding suspicious actions the application has performed that may indicate that the application poses some risk. For example, the suspicious actions may include requiring permissions that the user thinks are not related to the intended functionality of the application, performing an action with information gathered from the platform which the user did not anticipate, such as sending user private information to unintended recipients, etc.

For example, developer reputation may have a predetermined number of levels, e.g., two levels, e.g., trusted developer or distrusted developer, or three levels adding a level of unknown developer/developer with unknown level of reputation, etc. Alternatively, the developer reputation parameter may be a grade on a scale, for example, ranging from 1 to 100, from distrusted developer to trusted developer, respectively.
Applications may be categorized to a list of application categories according to the functionality of the application. Application categories may include games, utility, etc. application information may include the category of the application. Category lists may differ between platforms. Most application distribution platforms, for example, Apple's AppStore, Google Play, Facebook App Center, etc., provide for each application the category of the application. The category may be determined and set by the developer of the application distribution platform or by the developer of the application. The category may be set manually if the application distribution platform does not provide the category of the application or if it is believed that the category provided by the application distribution platform is incorrect or improper.
The platform for which the application has been developed.
List of requested permissions. The available permissions and names of permissions may vary among different platforms.
Application statistics, including, but not limited to: the number of installations of the application, the number of removals of the application, the number of known trusts and the number of known reports. These parameters may be used in their raw form or as inputs to any applicable formula such as ratio or average etc. Application statistics may be received from the application distribution platform as well. In case it is not received from the application distribution platform, application statistics may be extrapolated from the statistics of users of the risk assessment application according to embodiments of the present invention. As used herein, trusts refer to reports received from users indicating the level of trust a user associates with a certain application. If high levels of trust are received for a certain application, this may indicate that this application is safe and may decrease the risk associated with that application. In some embodiments, a trust may be a notice sent by a user if the user trusts a certain application or feels it does not pose a risk. In this case, high amounts of trusts may indicate that this application is safe and may decrease the risk associated with that application.
Certifications indicating whether the application was certified by a risk assessment and notification tool according to embodiments of the present application or by other risk assessment tool. This information may be received from the application distribution platform, from the developer of the application or from a third party that has certified the application.

In block 130, at least one list of permissions related to the category of the application may be obtained. Such a list may include permissions that are suitable and appropriate for the category of the application. Additionally or alternatively, a list including permissions that are inappropriate for the category of the application may be obtained. The lists of appropriate permissions and the list of inappropriate permissions for each category may be prepared in advance. For example, a list of appropriate permissions for “Games” application category may include permissions such as: first name, last name and email account (which allows access to the user's first name, last name and e-mail address, respectively), whereas permission such as friends work history (which allows access to the user's friends history of work places) may be included in a list of inappropriate permissions for the “Games” category. An exemplary list of appropriate permissions for “Social tool” application category may include permissions to access to data items such as: first name, last name, email account, list of friends, location (which allows getting the current or past geographical position of the user), etc.

In block 140, the list of permissions requested by the application may be compared with the list of permissions related to the category of the application. The list of permissions requested by the application may be compared with the list that includes permissions that are appropriate for the category of the application, with the list that includes permissions that are inappropriate for the category of the application, or with both.

In block 150, a risk factor may be calculated for the application, based on the comparison with the list of appropriate permissions, or with the list of inappropriate permissions or with both. The risk factor may be calculated also by taking into account other relevant information such as the application's developer reputation and application statistics. The risk factor may include any rating, rank, hierarchy, scale or relative values of features or criteria, indicative of the risk the application poses. The risk factor may include a numerical value, for example, a number from 1 to 10, letters (A, B, C, . . . ), signs or symbols (+, −), words and phrases (e.g., ‘safe’, ‘risky’), etc.

An exemplary algorithm for calculating the risk factor is given hereinbelow. The permissions may be grouped to categories of permissions, such as information access, file access, geo location access, etc. Each permission category may be associated with a weight. The weight of a permission category may relate to the risk involved in granting the permissions pertaining to the permission category. For example, the risk involved in granting permissions pertaining to the information access category may be lower than the risk involved in granting permissions pertaining to the file access category. Accordingly, the weight of information access category may be lower than the weight of file access category. Additionally, the weight associated with each category of permissions may be different for different categories of applications, representing the level of inappropriateness of requesting permission pertaining to that category of permissions by application pertaining to a specific category of applications. The weight associated with each category of permissions may be different for different platforms as well.

The list of requested permissions may be scanned and the risk factor may be increased for each permission that does not appear in the list of appropriate permissions. For each permission that does not appear in the list of appropriate permissions, the risk factor may be increased by a predetermined risk value of the permission, or by the predetermined risk value of the permission multiplied by a weight of the category of the permission. The predetermined risk value of the permission may represent the potential risk of the specific permission and may have constant value for all permissions or may have different value for different permissions.

For example, this algorithm may be implemented using the following pseudo code:

```
For each permission in app_permissions:
  If permission not in app_category_permissions:
        App_Rank += permission_value * permission_type_weight
End For
App_Rank += developer_rank * developer_rank_weight
```

Where app_permissions is the list of permissions requested by the application, app_category_permissions is the list of appropriate permissions of the category of the application, App_Rank is the risk factor, permission_value is risk value of the permission, permission_type_weight is the weight associated with the category, developer_rank is a calculated value of the developer's reputation and developer_rank_weight is the weight associated with the developer_rank. The developer_rank_weight is a weight that adjusts the developer_rank when calculating the risk factor for different platforms. The developer_rank may have different weights for different platforms, affecting the significance of the developer_{—} rank_{—} weight in the final app_rank. The algorithm may be further elaborated to take into account other application information listed hereinabove such as application statistics and certifications by third parties.

In block 160, the user may be informed of the level of correlation between the permissions requested by the application and the predetermined list of permissions. Specifically, the user may be informed of any permission requested by the application that is not present in the predetermined list of appropriate permissions and/or any permission requested by the application that is present in the predetermined list of inappropriate permissions. The risk factor, as well as other relevant information, may be presented as well. The user may be notified by any applicable manner including, E-mail message, Desktop Notification, Mobile Notification, etc.

According to some embodiments of the present invention, the permissions of the platform may be divided into permissions categories that are indicative of the nature of the requested permission. The permissions requested by the application may be presented to the user as related to their corresponding category, on a display of the computing device. Presenting permissions requested by the application as related to their corresponding category may render the list of requested categories more understandable to the user, thus helping the user to make more knowledgeable decisions regarding grant of requests for permissions. A single permission may pertain to more than one permission category. Permission categories may include, for example:
Post messages in the user's name permission category—may include permissions required for an application to be able to post information in the name of the user as if the user was the one posting.
Personal Information permission category—may include permissions required for an application to be able to access personal information of the user such as name, birthday, address etc.
Location permission category—may include permissions required for an application to be able to know current and/or past physical location of the user.
Access inbox or contacts permission category—may include permissions required for an application to be able to access the user's email box, messaging box and/or list of contacts.
Access your info 24/7 permission category—may include permissions required for an application to be able to access the user's information even when the user is not signed into the application or service and/or not currently using the application or service.
Access media & files permission category—may include permissions required for an application to be able to access the user's files including photos, videos, music, etc.

Some embodiments of the present invention may be implemented in software for execution by a processor-based system, for example, the method for risk assessment of an application. For example, certain embodiments of the present invention may be implemented in code or software and may be stored on a non-transitory storage medium having stored thereon instructions which, when executed by a processor, cause the processor to perform methods as discussed herein, and can be used to program a system to perform the instructions. The non-transitory storage medium may include, but is not limited to, any type of disk including floppy disks, optical disks, compact disk read-only memories (CD-ROMs), re-writable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom made or off the shelf hardware, firmware or a combination thereof.

Certain embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for risk assessment of installing and executing of an application executable on a platform, the method comprising:
a) categorizing the application to one of a list of application categories;
b) comparing permissions requested by the application to a predetermined list of permissions related to the category of the application and representing a permissible level of risk; and
c) providing information indicative of a level of correlation between the permissions requested by the application and the predetermined list of permissions.

2. The method of claim 1, further comprising:
d) calculating a risk factor of the application based on the level of correlation.

3. The method of claim 2, wherein the risk factor is also based on a reputation value of a developer of the application.

4. The method of claim 3, wherein the reputation value is calculated based on parameters selected from the list consisting of: i) number of applications the developer has for the platform, ii) number of applications the developer has for other platforms, iii) number of removed applications the developer has for various platforms, iv) number of trusted applications the developer has for various platforms and v) number of reported applications the developer has for various platforms.

5. The method of claim 2, wherein the risk factor is also based on application statistics.

6. The method of claim 5, wherein the application statistics is based on statistics selected from the list consisting of: i) number of installations of the application, ii) number of removals of the application, iii) number of known trusts and iv) number of known reports.

7. The method of claim 1, further comprising:
d) categorizing the permissions requested by the application to a list of permission categories; and
e) presenting to the user the permissions requested by the application as related to their corresponding category.

8. The method of claim 1, comprising receiving by the platform from the application'a list of permissions requested by the application.

9. The method of claim 1, wherein the platform is selected from the list consisting of: iOS®, Android™, Windows Phone™, Firefox™, Internet Explorer®, Google Chrome™, Safari®, Facebook®, Twitter® and Linkedin®.

10. A system for risk assessment of installing and executing of an application executable on a platform, the system comprising:
a processor to execute the platform and configured to:
a) categorize the application to one of a list of application categories;
b) compare permissions requested by the application to a predetermined list of permissions related to the category of the application and representing a permissible level of risk; and
c) provide information indicative of a level of correlation between the permissions requested by the application and the predetermined list of permissions.

11. The system of claim 10, wherein the processor is further configured to:
d) calculate a risk factor of the application based on the level of correlation.

12. The system of claim 11, wherein the risk factor is also based on a reputation value of a developer of the application.

13. The system of claim 12, wherein the reputation value is calculated based on parameters selected from the list consisting of: i) number of applications the developer has for the platform, ii) number of applications the developer has for other platforms, iii) number of removed applications the developer has for various platforms, iv) number of trusted applications the developer has for various platforms and v) number of reported applications the developer has for various platforms.

14. The system of claim 11, wherein the risk factor is also based on application statistics.

15. The system of claim 14, wherein the application statistics is based on statistics selected form the list consisting of: i) number of installations of the application, ii) number of removals of the application, iii) number of known trusts and iv) number of known reports.

16. The system of claim 10, wherein the processor is further configured to:
d) categorize the permissions requested by the application to a list of permission categories,
wherein the system comprises a display to present to the user the permissions requested by the application as related to their corresponding category.

17. The system of claim 10, wherein the platform is to receive from the application a list of permissions requested by the application.

18. The system of claim 10, wherein the platform is selected from the list consisting of: iOS®, Android™, Windows Phone™, Firefox™, Internet Explorer®, Google Chrome™, Safari®, Facebook®, Twitter® and Linkedin®.
